(19) United States
(12) Patent Application Publication
(10) Pub. No.: US 2026/0310727 A1
(43) Pub. Date: Oct. 8, 2026

(54) DATA ENHANCEMENT USING GRAPHS GENERATED WITH CLUSTERING METHODS

(71) Applicant: Dell Products L.P., Round Rock, TX (US)

(72) Inventors: ZIJIA WANG, London (GB); XIAOCHEN CHEN, Shanghai (CN); NING LI, Shanghai (CN); RUI CHEN, Shanghai (CN)

(21) Appl. No.: 19/098,864

(22) Filed: Apr. 2, 2025

(51) Int. Cl. G06F 16/901; G06F 16/28; G06N 20/00

(52) U.S. Cl. CPC G06F 16/9024; G06F 16/285; G06N 20/00

(57) ABSTRACT

Methods and systems for managing data sources of a distributed system are disclosed. The data sources may be managed by enhancing data used in servicing a request. The data may be enhanced using graphs that have been generated using clustering methods. The graphs may include nodes representing any portion of the data, first edges representing explicit relationships between the data, and/or second edges representing implicit relationships between the data. The data may be enhanced by identifying, from a first node, a second node using the second edges and/or including the any portion of the data represented by the first node with the data used in servicing the request. The implicit relationships of the graphs may be approved and/or rejected by stakeholders of the distributed system.

### FIELD

Embodiments disclosed herein relate generally to managing data sources of a distributed system. More particularly, embodiments disclosed herein relate to enhancing data used in servicing a request, the data being enhanced using graphs that have been generated using clustering methods.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2D show data flow diagrams illustrating operation of the distributed system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing data sources of a distributed system. The data sources may be managed by enhancing data used for servicing a request. The data may be enhanced by (i) performing a first collection of a first portion of the data from a data repository and/or (ii) performing a second collection of a second portion of the data using (a) the first portion of the data and/or graph data structures.

The graph data structures may include (a) nodes representing any first portion of the data, (b) first edges based on explicit relationships between the first portions of the data, and/or (c) second edges based on inferred relationships between the first portions of the data. The explicit relationships may include identifiable connections and/or structured connections between any sub-portions of the first portion of the data. The inferred relationships may include indirect connections (e.g., hidden variables, attribute similarities, underlying patterns, and/or any other indirect connection) between the any sub-portions of the first portion of the data.

The graph data structures may be generated using clustering algorithms. Embeddings of the any first portion of the data may be generated and/or the clustering algorithms may be used to identify, using the embeddings, embedding clusters. The embedding clusters may include a group of a portion of the embeddings that include provisional inferred relationships. The provisional inferred relationships may include the inferred relationships that have not yet been approved by and/or have been rejected by stakeholders of the distributed system. The stakeholders may include an administrator, a data scientist, and/or any other entity overseeing operation of the distributed system. Once the stakeholders approve the provisional inferred relationships of the embedding clusters, the provisional inferred relationships may be identified as inferred relationships.

The first collection may be performed, using content of the request, by performing a search for the first portion of the data from the data repository. Once the first collection has been performed, the second collection may be performed. The second collection may be performed by (i) selecting a first sub-portion of the first portion of the data, (ii) locating a first node representing the first sub-portion of the first portion of the data, (iii) locating a second node that is connected to the first node through an edge of the second edges between the first node and/or the second node, and/or (iv) obtaining, using the second node, the first sub-portion of the second portion of the data. The second collection may further be performed by locating other nodes that are connected to other second edges to obtain any sub-portions of the second portion of the data. The first portion of the data and/or the second portion of the data may be used, in servicing the request to provide desired computer implemented services.

In an embodiment, a method for managing data sources of a distributed system is disclosed. The method may include: (i) obtaining a request for data to be used to provide desired computer implemented services, (ii) performing a similarity based search of the data sources for the data to identify a first portion of the data from the data sources, (iii) performing a relationship based search of the data sources for the data using a graph data structure to identify a second portion of the data from the data sources, the graph data structure comprising: (a) nodes representing first portions of data stored in the data sources and available to service the request, (b) first edges based on explicit relationships between the first portions of the data, and (c) second edges based on inferred relationships between the first portions of the data, and (iv) servicing the request using, at least in part, the first portion of the data and the second portion of the data to facilitate provisioning of the desired computer implemented services.

The inferred relationships may be based on results generated by clustering algorithms to identify provisional inferred relationships.

The inferred relationships may be obtained based on stakeholder voting regarding the provisional inferred relationships.

The stakeholder voting may include voting, by stakeholders of the distributed system, to promote a third portion of the provisional inferred relationships to the inferred relationships.

A cluster identified by one of the clustering algorithms may include a first data point and a second data point, and the cluster satisfies at least one selected from a first group of relationships consisting of (i) the first data point is not directly causally related to the second data point, (ii) the first data point is a latent variable of the second data point, (iii) the first data point is similar to the second data point because the first data point includes a first attribute that is similar to a second attribute of the second data point, and (iv) the first data point and the second data point follow a pattern.

The clustering algorithms may be based on unsupervised learning.

The clustering algorithms may generate scores for qualities of clusters of the first portions of the data.

The qualities of the clusters may include at least one selected from a second group consisting of (i) a first measure of a number of the data points of the data of a cluster of the clusters, (ii) a second measure of a shape of the cluster, (iii) a third measure of cohesion of the cluster, the cohesion comprising distances between data points of the data of the cluster, a distance of the distances being based on a measure of similarity between the first data point and the second data point of the cluster, (iv) a fourth measure of separation between the cluster and a second cluster, and (v) a fifth measure of noise in the cluster, the noise comprising at least one outlying data point of the cluster.

The explicit relationships between the first portions of data may include at least one explicit relationship in a third group consisting of (i) directly correlated data, (ii) causally related data, (iii) categorically related data, (iv) hierarchically related data, (v) mathematically related data, and (vi) functionally related data.

The functionally related data may include at least a first input data with other input data used to generate a second output data in a function.

The mathematically related data may include an explicit relationship between the first input data and the other input data that are used in a mathematical operation.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

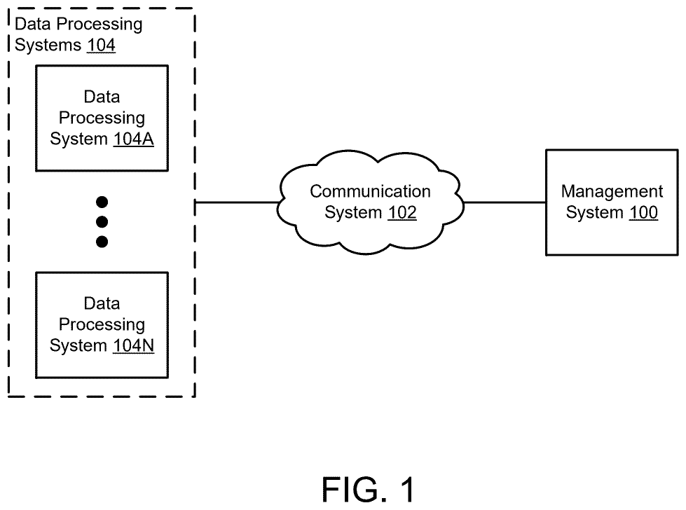

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a request for data may be obtained. The request for data may be obtained by receiving an input for the data from (i) a user, (ii) a device (e.g., an Internet of Things device and/or any other device), (iii) a data processing system through an application programming interface (API) call, etc. The data may include (i) customer data, (ii) financial data, (iii) geodetic data, (iv) energy consumption data, and/or (v) any other type of data stored and/or processed by the distributed system. The request may include (i) a user statement requesting the data, (ii) a Power-On Self-Test (POST) statement from the device, (iii) a webhook notification, etc.

Using any portion of the request, a similarity based search may be performed. The similarity based search may be performed by (i) generating first embeddings (e.g., a first n-dimensional vector and/or any other first numerical representation) of the data, (ii) collecting stored data from a data repository of the distributed system, (iii) generating second embeddings (e.g., a second n-dimensional vector and/or any other second numerical representation) of the stored data, and/or (iv) measuring a magnitude of similarity between the first embeddings and/or the second embeddings to obtain a first portion of the stored data that is determined to be sufficiently similar to the data.

The first portion of the stored data may be sufficiently similar to the data based on explicit relationships. The explicit relationships may be based on (i) direct correlations, (ii) causal relationships, (iii) categorical relationships, (iv) hierarchical relationships, (v) mathematical relationships, and/or (vi) functional relationships.

However, using the first portion of the stored data and/or the data to service the request, a provision of the computer implemented services may be impacted. The servicing may be impacted because a second portion of the stored data, which are linked to the data through inferred relationships, is not included in the servicing. Because the second portion of the stored data is not included, (i) the servicing may not include a comprehensive analysis, (ii) predictive analytics of the servicing may not be able to identify latent patterns, (iii) skewed analyses may be performed due to ingestion of the portion of the stored data and/or the data, leading to biases and/or incomplete results, and/or (iv) any other analysis performed in the servicing may lead to incomplete results.

In general, embodiments disclosed here relate to systems and methods for managing data sources of a distributed system. The data sources may be managed by (i) obtaining a request for data to be used to provide desired computer implemented services, (ii) performing a similarity based search of the data sources for the data to identify a first portion of the data from the data sources, (iii) performing a relationship based search of the data sources for the data using a graph data structure to identify a second portion of the data from the data sources, the graph data structure comprising (a) nodes representing first portions of data stored in the data sources and available to service the request, (b) first edges based on explicit relationships between the first portions of the data, and/or (c) second edges based on inferred relationships between the first portions of the data, and/or (iv) servicing the request using, at least in part, the first portion of the data and/or the second portion of the data to facilitate provisioning of the desired computer implemented services.

The request for the data may be obtained by receiving an input for the data from a first entity. The first entity may include (i) a user, (ii) a device (e.g., an Internet of Things device), (iii) a data processing system through an application programming interface (API) call, etc. The data may include (i) customer data, (ii) financial data, (iii) geodetic data, (iv) energy consumption data, and/or (v) any other type of data stored and/or processed by the distributed system. The request may include (i) a user statement requesting the data, (ii) a Power-On Self-Test (POST) statement from the device, (iii) a webhook notification, etc.

The similarity based search may be performed by (i) generating first embeddings (e.g., a first n-dimensional vector and/or any other first numerical representation) of the data, (ii) collecting stored data (i.e., the data of the data sources) from a data repository of the distributed system, (iii) generating second embeddings (e.g., a second n-dimensional vector and/or any other second numerical representation) of the stored data, and/or (iv) measuring a magnitude of similarity between the first embeddings and/or the second embeddings to obtain a first portion of the stored data that is determined to be sufficiently similar to the data.

The relationship based search may be performed by tracing the graph data structure from a first node of the graph data structure to a second node of the graph data structure that are linked by a second edge of the second edges. The graph data structure may be traced by (i) identifying the first node (e.g., based on the first portion of the stored data), (ii) identifying the second edge (e.g., based on an inferred relationship between a second portion of the stored data and/or the first portion of the stored data) of the first node, and/or (iii) identifying, using the second edge, the second node (e.g., based on the second portion of the stored data). The graph data structure may be further traced to identify, using other second edges, other nodes.

The inferred relationship may include (i) the first portion not being correlated and/or not directly causal of the second portion, (ii) the first portion being a latent variable of the second portion, (iii) the first portion being similar to the second portion because the first portion and/or the second portion include at least one similar attribute, and/or (iv) the first portion and/or the second portion following a pattern.

The inferred relationship of the inferred relationships from the graph data structure may be identified using clustering algorithms. The clustering algorithms may include (i) K-means Clustering, (ii) DBSCAN (Density-Based Spatial Clustering of Applications with Noise), (iii) Mean Shift Clustering, (iv) Gaussian Mixture Models, etc. Using the clustering algorithms and/or the data of the data sources, provisional inferred relationships may be identified between the data of the data sources. The provisional inferred relationships may include the inferred relationships that have not yet been accepted by and/or have been rejected by stakeholders of the distributed system.

To identify the inferred relationships from the provisional inferred relationships, stakeholder voting may be performed. To perform stakeholder voting, stakeholders (e.g., an administrator, a data scientist, and/or any other second entity overseeing operation of the distributed system) may vote to promote a provisional inferred relationship of the provisional inferred relationships to be an inferred relationship of the inferred relationships. The inferred relationships may then be included in the graph data structure during generation of the graph data structure.

Finally, the request may be serviced using, at least in part, the first portion of the data and the second portion of the data to facilitate provisioning of the desired computer implemented services. The request may be serviced by (i) transmitting the request and/or at least the first portion of the data and/or the second portion of the data, to the data processing system of the distributed system, (ii) performing, by the data processing system and/or at least the first portion of the data and/or the second portion of the data, at least one task (e.g., (i) a computation, (ii) a transformation, (iii) a validation, and/or (iv) any other task) of the request, (iii) generating, by the data processing system, a response of the performance of the at least one task, and/or (iv) transmitting the response to the first entity. The response may include (i) a list of the at least one task that was performed, (ii) an identification number of the data processing system that serviced the request and/or any other data processing system that assisted in the servicing, (iii) status messages concerning at least a result of the performance of the at least one task, (iv) output data generated by the at least one task, etc.

To provide the above noted functionality, the system may include management system 100, and data processing systems 104. Each of these components is discussed below.

Data processing systems 104 may include any number of data processing systems 104A-104N. The any number of data processing systems 104A-104N may include stakeholder devices. A stakeholder of the stakeholder devices may include an administrator, a data scientist, and/or any other entity overseeing operation of the distributed system.

Data processing systems 104 and/or management system 100 may include at least one data repository of the distributed system. The at least one data repository may be used to store data of the distributed system.

The any number of data processing systems 104A-104N and/or management system 100 may include hardware, software, network resources, etc. by which data of the data sources are obtained and/or transformed into embeddings (e.g., an n-dimensional vector and/or any other numerical representation). The any number of data processing systems 104A-104N and/or management system 100 may also include clustering algorithms with which provisional inferred relationships between the embeddings are identified. The clustering algorithms may include (i) K-means Clustering, (ii) DBSCAN (Density-Based Spatial Clustering of Applications with Noise), (iii) Mean Shift Clustering, (iv) Gaussian Mixture Models, etc.

At least the provisional inferred relationships may be transmitted to stakeholder devices. The hardware, the software, the network resources, etc. may be used on the stakeholder devices by the stakeholders to review a quality of the provisional inferred relationships. Through the review of the quality, inferred relationships of the embeddings may be selected by the stakeholders.

With the data, the inferred relationships of the data and/or explicit relationships of the data, graph data structures may be generated using the hardware and/or the software of the distributed system. On the graph data structures, nodes, based on the data, may be added to the graph data structures. Then, first edges, based on the explicit relationships of the data, and/or second edges, based on the inferred relationships of the data, may be added between the nodes. The graph data structures may be stored in the at least one repository of the distributed system.

To service a request for a provision of desired computer implemented services, the any number of data processing systems 104A-104N and/or management system 100 may receive the request. The request may be assigned and/or transmitted to the any number of data processing systems 104A-104N for servicing. The any number of data processing systems 104A-104N may (i) perform a search for first data in the at least one repository using the request, (ii) generate the embeddings of the first data and/or the data of the request, (iii) identify, using a similarity based search, a first portion of data that is similar to the data of the request, (iv) perform a trace using graph data structures, starting from a first node (e.g., based on the first portion of the data) to identify at least a second node (e.g., based on the first portion of the data), the first node being connected to the second node through a second edge.

The any number of data processing systems 104A-104N may use the first data and/or second data, on which the second nodes are based, to service the request. To service the request, the any number of data processing systems 104A-104N may use the hardware, the software, the network resources, etc. to perform at least one task (e.g., (i) a computation, (ii) a transformation, (iii) a validation, and/or (iv) any other task) associated with the request.

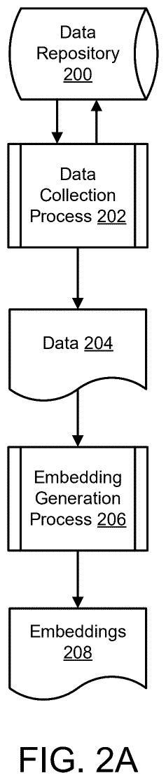

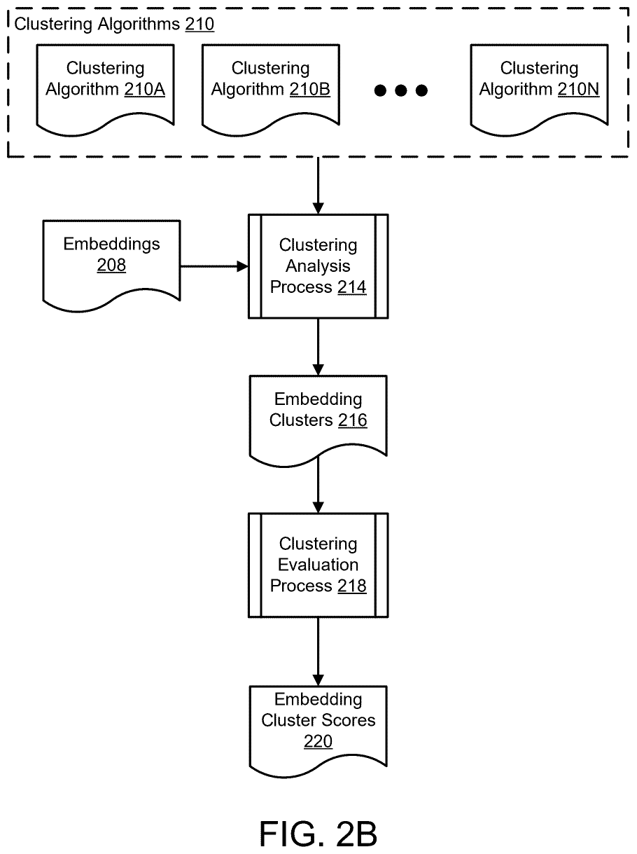

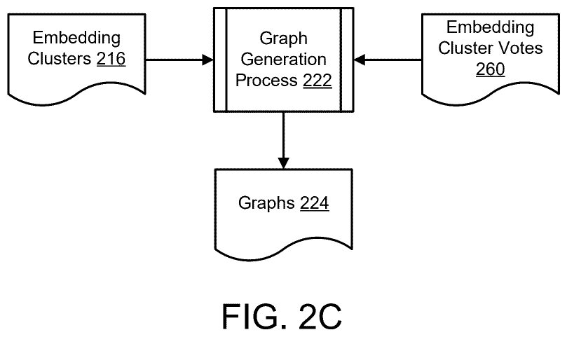

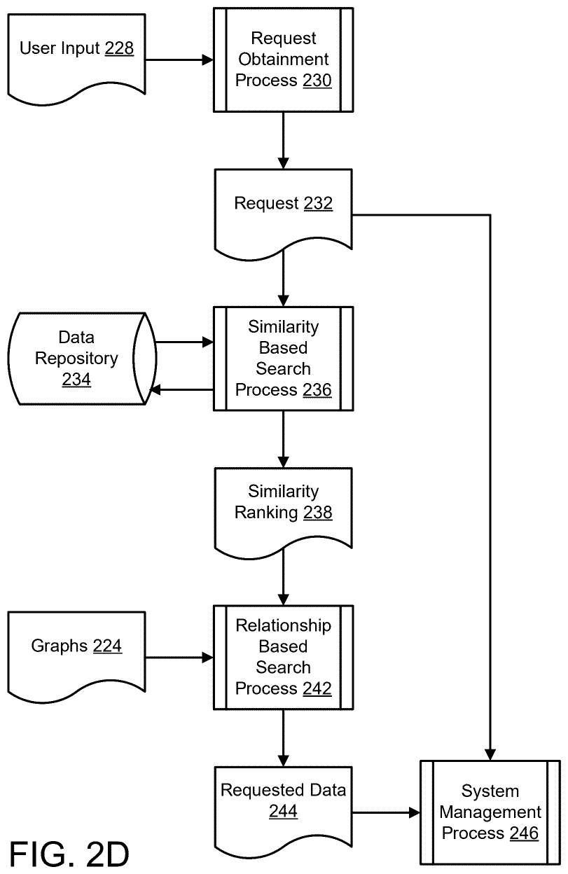

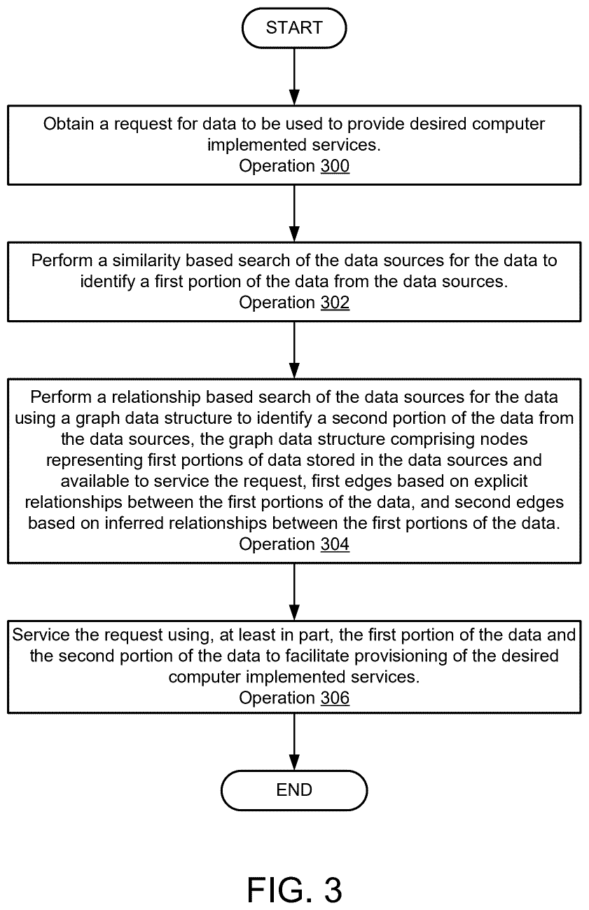

While providing their functionality, any of management system 100 and data processing systems 104 may perform all, or a portion, of the flows and methods shown in FIGS. 2A-3.

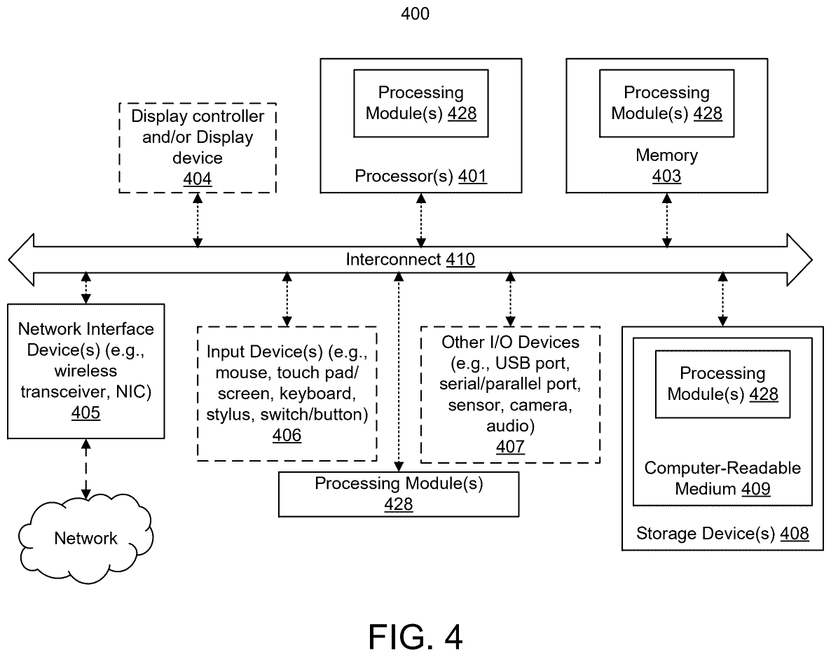

Any of (and/or components thereof) management system 100 and data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 204, 208, etc.) is used to represent data structures, a second set of shapes (e.g., 202, 206, etc.) is used to represent processes performed using and/or that generate data, and a third set of shapes (e.g., 200, 234, etc.) is used to represent large scale data structures such as databases.

Turning to FIG. 2A, a first data flow diagram in accordance with an embodiment is shown. The first data flow diagram may illustrate data used in and data processing performed in generating embeddings of data from a data source.

To generate the embeddings (e.g., 208) of the data (e.g., 204), a data collection process (e.g., 202) may be performed. During the data collection process (e.g., 202), the data (e.g., 204) may be collected. The data (e.g., 204) may be collected from a data repository (e.g., 200).

The data repository (e.g., 200) may include (i) relational databases (e.g., in which structured data in tables are stored with schemas, such as (a) Structured Query Language (SQL), (b) PostgreSQL, (c) Microsoft SQL Server, and/or (d) any other predefined schema), (ii) data warehouses (e.g., centralized repositories optimized for analytical processing and/or reporting), (iii) data lakes (e.g., in which vast amounts of raw and/or unstructured data is stored for later processing), (iv) metadata repositories (e.g., in which second data about data in stored to aid in data management), etc.

The data (e.g., 204) may include (i) the structured data in the tables, (ii) historical data (e.g., any data that maintains a relevance over a period of time), (iii) transactional data (e.g., data that includes information about transactions between data processing systems), (iv) metadata, (v) the raw and/or the unstructured data, etc.

The data (e.g., 204) may be collected by extracting the data (e.g., 204) using (i) SQL queries, (ii) application programming interface (API) calls, (iii) any tools and/or scripts of software development kits (SDKs), and/or (iv) any other of the tools, the scripts, the queries, etc. of the schemas, interfaces, software, etc. After the extraction, the data (e.g., 204) may be cleaned by (i) standardizing the data to align with a format, (ii) modifying, adding, and/or removing any missing attributes of the data (e.g., 204), (iii) removing duplicate records, (iv) correcting (a) typographical errors, (b) inconsistencies, and/or (c) inaccuracies, (v) performing deduplication by merging records of the data (e.g., 204) that represent a same portion of the data (e.g., 204), and/or (iv) performing any other operation to clean the data (e.g., 204).

Once the data (e.g., 204) has been extracted, an embedding generation process (e.g., 206) may be performed. During the embedding generation process (e.g., 206), the data (e.g., 204) may be ingested by trained machine learning models (e.g., neural networks, etc.) that use techniques such as (a) Word2Vec, (b) GloVe (Global Vectors for Word Representation), (c) FastText, and/or (d) any other any other technique. The trained machine learning models (e.g., neural networks, etc.) may use the techniques to transform the data (e.g., 204) into the embeddings (e.g., 208).

The embeddings (e.g., 208) may include an n-dimensional vectors and/or any other numerical representation of the data (e.g., 208). The embeddings may include a semantic similarity between the data (e.g., 204). For example, a first embedding and/or a second embedding, each of which include at least a first component value and/or a second component value that are similar, may include semantic similarity. The embeddings (e.g., 208) may also include context of the data (e.g., 204) by ingesting the surrounding context of the data (e.g., 204) during the embedding generation process (e.g., 206). For example, in a description message of the metadata of the data (e.g., 204), the context of the description message may include (i) tags, (ii) timestamps, (iii) source information, etc. The context of the description message may be included in a generation of an embedding of the description message to modify at least one component value of the embedding of the description message.

Thus, via the first data flow diagram illustrated in FIG. 2A, a system in accordance with an embodiment may generate the embeddings (e.g., 208) of the data (e.g., 204). Consequently, the distributed system may be more likely to be able to provide desired computer implemented services by having the data (e.g., 204) in a format of a numerical representation that a clustering analysis process can ingest.

Turning to FIG. 2B, a second data flow diagram in accordance with an embodiment is shown. The second data flow diagram may illustrate data used in and data processing performed in generating embedding cluster scores (e.g., 220) of embedding clusters (e.g., 216) that are generated by a clustering analysis process (e.g., 214).

To generate the embeddings cluster scores (e.g., 220) of the embedding clusters (e.g., 216), a clustering analysis process (e.g., 214) may be performed. During the clustering analysis process (e.g., 214), embeddings (e.g., 208) and/or clustering algorithms (e.g., 210) may be ingested to generate embedding clusters (e.g., 216). The embeddings (e.g., 208) are described in the description of FIG. 2A.

The clustering algorithms (e.g., 210) may include any number of clustering algorithms (e.g., 210A, 210B, . . . , 210N), The any number of the clustering algorithms (e.g., 210A, 210B, . . . , 210N) may include (i) K-means Clustering, (ii) DBSCAN (Density-Based Spatial Clustering of Applications with Noise), (iii) Mean Shift Clustering, (iv) Gaussian Mixture Models, etc.

During the clustering analysis process (e.g., 214), the any number of the clustering algorithms (e.g., 210A, 210B, . . . , 210N) may ingest the embeddings (e.g., 208) to generate the embedding clusters (e.g., 216). The embedding clusters (e.g., 216) may be generated by performing a similarity based search on a portion of the embedding clusters (e.g., 216). The similarity based search may include (i) selecting a first embedding of the embeddings (e.g., 208) based on a first portion of the data (e.g., 204), (ii) selecting a second embedding of the embeddings (e.g., 208) based on a second portion of the data (e.g., 204), (iii) performing a similarity computation using the first embedding and/or the second embedding to generate a similarity score, (iv) repeating the selection of at least two embeddings and/or performance of the similarity computation with the at least two embeddings, and/or (v) grouping embeddings based on similarity scores to generate the embedding clusters (e.g., 216).

The similarity computations may include computations of a cosine similarity, a Euclidean distance, a Jaccard similarity, a Manhattan distance, a Minkowski Distance, and/or any other distance. Similarity scores of the similarity computations may include different ranges based on the similarity computations. In a first example, a cosine similarity score includes a single integer bounded and/or including 0.0 and/or 1.0. The cosine similarity score further includes a measure of an angle between two vectors of the numerical representations. A first score of 1.0 includes perfect similarity between the two vectors and/or a second score of 0.0 includes no similarity between the two vectors. In a second example, a Euclidean distance also includes the single integer bounded and/or including 0.0 and/or infinity. The Euclidean distance further includes a straight line distance between two points in multi-dimensional space. The two points may be obtained from the two vectors of the numerical representations. A low value for the Euclidean distance may include high similarity between the two vectors and/or a high value for the Euclidean distance may include low similarity between the two vectors.

The embeddings may be grouped by (i) assigning initial portions of embeddings to clusters, (ii) computing centroids for the clusters, (iii) reassigning similar portions and/or different portions of the embeddings to the clusters, and/or (iv) recomputing the centroids for the clusters. The centroid may include a mean embedding location of portions of the embeddings that are assigned to a cluster. Assignments of the similar portions and/or the different portions of the embeddings to the clusters and/or computations of the centroids may continue until a convergence criterion has been reached. The convergence criterion may include (a) a small magnitude of at least one difference in the portions of the embeddings in the assignments, (b) a maximum number of the assignments and/or the computations of the centroid, etc.

Once the embedding clusters (e.g., 216) have been generated, a clustering evaluation process (e.g., 218) may be performed. During the clustering evaluation process (e.g., 218), the embedding clusters (e.g., 216) may be evaluated to generate the embedding cluster scores (e.g., 220). The embedding clusters (e.g., 216) may be evaluated by measuring at least one quality of each embedding cluster of the embedding clusters (e.g., 216). Based on the at least one quality, an embedding cluster score of the embedding cluster scores (e.g., 218) may be computed.

The at least one quality may include (a) a first measure of a number of the embeddings (e.g., 208) within a cluster of the clusters, (b) a second measure of a shape of the cluster, (c) a third measure of cohesion of the cluster, the cohesion comprising distances between the embeddings (e.g., 208) of the data (e.g., 204) of the cluster, a distance of the distances being based on a measure of similarity between the first embedding and the second embedding of the cluster, (d) a fourth measure of separation between the cluster and a second cluster, and/or (e) a fifth measure of noise in the cluster, the noise comprising at least one outlying embedding of the cluster.

For example, the first measure may increase and/or decrease in magnitude respectively with an increasing number and/or a decreasing number of the embeddings (e.g., 208). The second measure may depend on any relationships between the embeddings (e.g., 208). So, if the cluster includes the embeddings (e.g., 208). with more relationships, the second measure may increase in magnitude because the cluster may be more circular in shape. However, if the cluster includes the embeddings (e.g., 208) with less relationships, the second measure may decrease in magnitude because the cluster may be more linear in shape. The third measure may increase in magnitude because the distances between the embeddings (e.g., 208) may be shorter. However, the third measure may decrease in magnitude because the distances may be longer. As the cluster may be further separated from the second cluster, the fourth measure may increase. With less noise that is included in the cluster, the fifth measure may increase in magnitude. For the cluster, an embedding cluster score of the embedding cluster scores (e.g., 218) may include a sum of (i) the first measure, (ii) the second measure, (iii) the third measure, (iv) the fourth measure, and/or (v) the fifth measure.

Thus, via the second data flow diagram illustrated in FIG. 2B, a system in accordance with an embodiment may generate the embedding cluster scores (e.g., 220). Consequently, the distributed system may be more likely to be able to provide desired computer implemented services by describing an overall quality, based on individual qualities, of the embedding clusters (e.g., 216).

Turning to FIG. 2C, a third data flow diagram in accordance with an embodiment is shown. The third data flow diagram may illustrate data used in and data processing performed in generating graphs (e.g., 224) of the embedding clusters (e.g., 216).

To generate the graphs (e.g., 224) of the embedding clusters (e.g., 216), a graph generation process (e.g., 222) may be performed. During the graph generation process (e.g., 222), embedding clusters (e.g., 216) and/or embedding cluster votes (e.g., 260) may be ingested in the graph generation process (e.g., 222) to generate the graphs (e.g., 224).

The embedding clusters (e.g., 216) are described in the description of FIG. 2B. The embedding cluster votes (e.g., 260) may be generated by voting, by stakeholders of the distributed system, for at least one embedding cluster of the embedding clusters (e.g., 216). The stakeholders may include (i) an administrator, (ii) a data scientist, and/or (iii) any other entity overseeing operation of the distributed system.

The embedding clusters (e.g., 216) may include a portion of embeddings (e.g., 208). The portion of the embeddings (e.g., 208 from FIG. 2A) may be based on a portion of data (e.g., 204 from FIG. 2A) that include inferred relationships and/or explicit relationships of the portion.

The explicit relationships may include (i) directly correlated data, (ii) causally related data, (iii) categorically related data, (iv) hierarchically related data, (v) mathematically related data and/or (v) functionally related data. The directly correlated data may include a first portion that changes with a second portion of the data. For example, increasing a first magnitude of a first value of the first portion means that a second magnitude of a second value of the second portion increases. The causally related data may include that a first change in the first portion directly leads to a second change in the second portion. The categorically related data may include that the first portion and/or the second portion may be included in a category. The hierarchically related data may include that the first portion and/or the second portion may be linked to each other between at least one level in a tree and/or a hierarchy (e.g., a parent-child relationship, a folder structure, a taxonomy, and/or any other tree and/or hierarchy). The functionally related data may include at least the first portion and/or the second portion used as inputs and/or outputs of a function. The mathematically related data may include an explicit relationship between the first portion and/or the second portion as the inputs and/or the outputs that are used in a mathematical operation.

The provisional inferred relationships may include inferred relationships that have not been approved by the stakeholders. The inferred relationships may include non-explicit relationships between the embeddings (e.g., 208) (e.g., based on any portion of the data (e.g., 204)) of an embedding cluster of the embedding clusters (e.g., 216). The inferred relationships between the any portion of the data (e.g., 204) may include at least one selected from a group of relationships consisting of: (i) the first portion of the data (e.g., 204) may not be directly causally related to the second portion of the data (e.g., 204), (ii) the first portion may be a latent variable of the second portion, (iii) the first portion may be similar to the second portion because the first portion includes a first attribute that is similar to a second attribute of the second portion, and/or (iv) the first portion and the second portion follow a pattern.

The provisional inferred relationships may be approved by the stakeholders by performing stakeholder voting based on at least the embedding cluster scores (e.g., 220 from FIG. 2B) and/or at least the embedding clusters (e.g., 216). Stakeholders may perform the stakeholder voting by performing any assessment of the embedding cluster scores (e.g., 220) and/or the embedding clusters (e.g., 216). Based on the any assessment, the stakeholders may accept and/or reject an embedding cluster of the embedding clusters (e.g., 216) and/or record the acceptance and/or the rejection of the embedding cluster in the embedding cluster votes (e.g., 260).

During the graph generation process (e.g., 222), the graphs (e.g. 224) may be generated using the embedding clusters (e.g., 216) and/or the embedding cluster votes (e.g., 260). To generate the graphs (e.g., 224), an embedding cluster of the embedding clusters (e.g., 216) that includes a majority acceptance vote of the embedding cluster votes (e.g., 260) may first be selected. Nodes may be added to an empty graph data structure and/or arranged following an arrangement of the embeddings (e.g., 208) of the embedding cluster. Any metadata, tags, and/or content of the data point may be included with the nodes. Then, first edges may be added between the nodes based on the explicit relationships between the nodes. Finally, second edges may be added between the nodes based on the inferred relationships between the nodes.

Thus, via the third data flow diagram illustrated in FIG. 2C, a system in accordance with an embodiment may generate the graphs (e.g., 224) of the embedding clusters (e.g., 216). Consequently, the distributed system may be more likely to be able to provide desired computer implemented services by generating the graphs (e.g., 224) that include the explicit relationships and/or the inferred relationships of the embedding clusters (e.g., 216).

Turning to FIG. 2D, a fourth data flow diagram in accordance with an embodiment is shown. The fourth data flow diagram may illustrate data used in and data processing performed in servicing a request (e.g., 232) using the graphs (e.g., 224).

To service the request (e.g., 232), a request obtainment process (e.g., 230) may be performed. During the request obtainment process (e.g., 230), a user input (e.g., 228) may be obtained and/or ingested to generate a request (e.g., 232). The user input (e.g., 228) may include a generic and/or unstructured request for services. The user input (e.g., 228) may include, for example, a statement such as “retrieve any personal identifiable information of employees hired in the last year”, “provide the locations of the delivery vans,” “can you provide energy consumption information on all data processing systems?”

During the request obtainment process (e.g., 230), the user input (e.g., 228) may be ingested by a trained generative machine learning model (e.g., a large language model, a small language model, and/or any other natural language processing models, etc.) to generate the request (e.g., 232). The trained generative machine learning model may be adapted to generate a structured request, including the request (e.g., 232), for the services.

The request (e.g., 232) may include at least one structured request. The at least one structured request may include (i) a text data file, (ii) a hierarchical data file, (iii) a command data file, etc. that includes (i) an first identification of a user that submitted the request, (ii) a timestamp, (iii) a criticality level (e.g., low, medium, high, severe), (iv) a second identification of at least one data processing system on which the service is performed, (v) classifications of data needed to perform the service, (vi) metadata, tags, keywords, statements, etc. with which are used to find associated data needed to perform the services, (vii) any other content associated with the request (e.g., 232).

The request (e.g., 232) may be ingested by a similarity based search process (e.g., 236). During the similarity based search process (e.g., 236), the content of the request (e.g., 232) may be used to perform a similarity based search to obtain a first portion of data from a data repository (e.g., 234). The data repository may be similar to a second repository (e.g., 200) described in the description of FIG. 2A.

During the similarity based search process (e.g., 236), the first portion of the data may be obtained through, for example, (i) a keyword search, (ii) a semantic search, (iii) a contextual search and/or (iv) any other search using the content of the request (e.g., 232). One the first portion of the data has been obtained, first embeddings of the first portion of the data may be obtained. The first embeddings may be generated using an embedding generation process (e.g., 206) described in the description of FIG. 2A. Once the first embeddings are generated, similarity scores between the content of the request (e.g., 232) and/or the first embeddings may be computed using similarity computations that are similar to the similarity computations described in the description of FIG. 2B to generate similarity scores.

A similarity ranking (e.g., 238) may be obtained by ranking the similarity scores with first magnitudes of the similarity scores that indicate higher similarity being assigned higher rankings and/or second magnitudes of the similarity scores that indicate lower similarity being assigned lower rankings.

The similarity rankings (e.g., 238) and/or the graphs (e.g., 224) may be ingested by a relationship based search process (e.g., 242). During the relationship based search process (e.g., 242), requested data (e.g., 244) may be obtained. The requested data (e.g., 244) may be obtained by (i) selecting a first sub-portion of the first portion of the data that is associated with a highest similarity ranking of the similarity ranking (e.g., 238), (ii) locating a first node on a graph of the graphs (e.g., 224), the node based on the first sub-portion of the first portion of the data, (iii) performing a trace on the graph to locate other nodes of the graph, (iv) adding other sub-portion based on the other nodes to the first portion of the data to obtain the requested data (e.g., 244), and/or (v) repeating previous steps using at least a second sub-portion of the first portion of the data to further enrich a quality of the requested data (e.g., 244).

The trace may be performed by identifying, from the first node, a second node connected to the first node through a first edge that is based on a inferred relationship between the first sub-portion of the first node and/or the second sub-portion of the second node. Qualities of the inferred relationship are detailed in the description of FIG. 2C. The trace may be continued to identify, from the second node, a third node connected to the second node through a second edge that is based on a second inferred relationship between the second sub-portion of the second node and/or a third sub-portion of the third node.

The requested data (e.g., 244) and/or the request (e.g., 232) may be ingested by a system management process (e.g., 246). During the system management process (e.g., 246), the request may be serviced by a data processing system of the distributed system. The request (e.g., 232) may be serviced by (i) transmitting the request (e.g., 232) and/or at least the requested data (e.g., 244) to the data processing system, (ii) performing, by the data processing system and/or using at least the requested data (e.g., 244), at least one task (e.g., (i) a computation, (ii) a transformation, (iii) a validation, and/or (iv) any other task) of the request (e.g., 232), (iii) generating, by the data processing system, a response of the performance of the at least one task, and/or (iv) transmitting the response to an entity that submitted the user input (e.g., 228) to the distributed system. The response may include (i) a list of the at least one task that was performed, (ii) an identification number of the data processing system that serviced the request and/or any other data processing system that assisted in the servicing, (iii) status messages concerning at least a result of the performance of the at least one task, (iv) output data generated by the at least one task, etc.

Thus, via the fourth data flow diagram illustrated in FIG. 2D, a system in accordance with an embodiment may service the request (e.g., 232) using the graphs (e.g., 224). Consequently, the distributed system may be more likely to be able to provide desired computer implemented services by using the requested data (e.g., 244) obtained from graphs (e.g., 224) that include the inferred relationships of data obtained from the data repository (e.g., 234).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data sources of a distributed system. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the data sources of the distributed system in accordance with an embodiment is shown. The method may be performed, for example, by any of the components of the system of FIG. 1, and/or other components not shown therein.

At operation 300, a request for data may be obtained to be used to provide desired computer implemented services. The request may be obtained by receiving an input for the data from a first entity. The first entity may include (i) a user, (ii) a device (e.g., an Internet of Things device), (iii) a data processing system through an application programming interface (API) call, etc. The data may include (i) customer data, (ii) financial data, (iii) geodetic data, (iv) energy consumption data, and/or (v) any other type of data stored and/or processed by the distributed system. The request may include (i) a user statement requesting the data, (ii) a Power-On Self-Test (POST) statement from the device, (iii) a webhook notification, etc.

At operation 302, a similarity based search of the data sources may be performed for the data to identify a first portion of the data from the data sources. The similarity based search may be performed by (i) generating first embeddings (e.g., a first n-dimensional vector and/or any other first numerical representation) of the data, (ii) collecting stored data (i.e., the data of the data sources) from a data repository of the distributed system, (iii) generating second embeddings of the stored data, and/or (iv) measuring a magnitude of similarity between the first embeddings and/or the second embeddings to obtain a first portion of the stored data that is determined to be sufficiently similar to the data.

At operation 304, a relationship based search of the data sources may be performed for the data using a graph data structure to identify a second portion of the data from the data sources, the graph data structure comprising nodes representing first portions of data stored in the data sources and available to service the request, first edges based on explicit relationships between the first portions of the data, and second edges based on inferred relationships between the first portions of the data. The relationship based search may be performed by tracing the graph data structure from a first node of the graph data structure to a second node of the graph data structure that are linked by a second edge of the second edges. The graph data structure may be traced by (i) identifying the first node (e.g., based on the first portion of the stored data), (ii) identifying the second edge (e.g., based on an inferred relationship of the inferred relationships between a second portion of the stored data and the first portion of the stored data) of the first node, and/or (iii) identifying, using the second edge, the second node (e.g., based the second portion of the stored data). The graph data structure may be further traced to identify, using other second edges, other nodes.

At operation 306, the request may be serviced using, at least in part, the first portion of the data and the second portion of the data to facilitate provisioning of the desired computer implemented services. The request may be serviced by (i) transmitting the request and/or at least the first portion of the data and/or the second portion of the data, to the data processing system of the distributed system, (ii) performing, by the data processing system and/or at least the first portion of the data and/or the second portion of the data, at least one task (e.g., (i) a computation, (ii) a transformation, (iii) a validation, and/or (iv) any other task) of the request, (iii) generating, by the data processing system, a response of the performance of the at least one task, and/or (iv) transmitting the response to the first entity. The response may include (i) a list of the at least one task that was performed, (ii) an identification number of the data processing system that serviced the request and/or any other data processing system that assisted in the servicing, (iii) status messages concerning at least a result of the performance of the at least one task, (iv) output data generated by the at least one task, etc.

The method may end following operation 306.

Thus, via the method shown in FIG. 3, embodiments herein may likely improve a likelihood of managing the data sources of the distributed system. By improving the likelihood of managing the data sources of the distributed system, the distributed system may be more likely to provide desirable computer implemented services by, for example, generating graph data structures that include the nodes and the second edges, using the graph data structures to identify a second node, representing a second sub-portion of the first portion of the data, from a first node, representing a first sub-portion of the first portion of the data, using a second edge, based on an inferred relationship between the first sub-portion and the second sub-portion, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing data sources of a distributed system, the method comprising:
obtaining a request for data to be used to provide desired computer implemented services;
generating embeddings of the data, wherein the embeddings comprise a tag of the data, a timestamp of the data, and source information of the data;
generating a graph data structure based on the embeddings;
performing a similarity based search of the data sources for the data to identify a first portion of the data from the data sources;
performing a relationship based search of the data sources for the data using the graph data structure to identify a second portion of the data from the data sources, the graph data structure comprising:
nodes representing first portions of data stored in the data sources and available to service the request,
first edges based on explicit relationships between the first portions of the data, and
second edges based on inferred relationships between the first portions of the data; and
servicing the request using, at least in part, the first portion of the data and the second portion of the data to facilitate provisioning of the desired computer implemented services.

2. The method of claim 1, wherein the inferred relationships are based on results generated by clustering algorithms to identify provisional inferred relationships.

3. The method of claim 2, wherein the inferred relationships are obtained based on stakeholder voting regarding the provisional inferred relationships.

4. The method of claim 3, wherein the stakeholder voting comprises voting, by stakeholders of the distributed system, to promote a third portion of the provisional inferred relationships to the inferred relationships.

5. The method of claim 2, wherein a cluster identified by one of the clustering algorithms comprises a first data point and a second data point, and the cluster satisfies at least one selected from a first group of relationships consisting of:
the first data point is not directly causally related to the second data point;
the first data point is a latent variable of the second data point;
the first data point is similar to the second data point because the first data point comprises a first attribute that is similar to a second attribute of the second data point; and
the first data point and the second data point follow a pattern.

6. The method of claim 5, wherein the clustering algorithms are based on unsupervised learning.

7. The method of claim 6, wherein the clustering algorithms generate scores for qualities of clusters of the first portions of the data.

8. The method of claim 7, wherein the qualities of the clusters comprise at least one selected from a second group consisting of:
a first measure of a number of data points of the data of a cluster of the clusters;
a second measure of a shape of the cluster;
a third measure of cohesion of the cluster, the cohesion comprising distances between data points of the data of the cluster, a distance of the distances being based on a measure of similarity between the first data point and the second data point of the cluster;
a fourth measure of separation between the cluster and a second cluster; and
a fifth measure of noise in the cluster, the noise comprising at least one outlying data point of the cluster.

9. The method of claim 1, wherein the explicit relationships between the first portions of data comprise at least one explicit relationship in a third group consisting of:
directly correlated data;
causally related data;
categorically related data;
hierarchically related data;
mathematically related data; and
functionally related data.

10. The method of claim 9, wherein the functionally related data comprises at least a first input data with other input data used to generate a second output data in a function.

11. The method of claim 10, wherein the mathematically related data comprises an explicit relationship between the first input data and the other input data that are used in a mathematical operation.

12. A non-transitory machine-readable medium having instructions stored therein, which when executed by a processor, cause the processor to perform operations for managing data sources of a distributed system, the operations comprising:
obtaining a request for data to be used to provide desired computer implemented services;
generating embeddings of the data, wherein the embedding comprises a tag of the data, a timestamp of the data, and source information of the data;
generating a graph data structure based on the embeddings;
performing a similarity based search of the data sources for the data to identify a first portion of the data from the data sources;
performing a relationship based search of the data sources for the data using the graph data structure to identify a second portion of the data from the data sources, the graph data structure comprising:
nodes representing first portions of data stored in the data sources and available to service the request,
first edges based on explicit relationships between the first portions of the data, and
second edges based on inferred relationships between the first portions of the data; and
servicing the request using, at least in part, the first portion of the data and the second portion of the data to facilitate provisioning of the desired computer implemented services.

13. The non-transitory machine-readable medium of claim 12, wherein the inferred relationships are based on results generated by clustering algorithms to identify provisional inferred relationships.

14. The non-transitory machine-readable medium of claim 13, wherein the inferred relationships are obtained based on stakeholder voting regarding the provisional inferred relationships.

15. The non-transitory machine-readable medium of claim 14, wherein the stakeholder voting comprises voting, by stakeholders of the distributed system, to promote a third portion of the provisional inferred relationships to the inferred relationships.

16. The non-transitory machine-readable medium of claim 13, wherein a cluster identified by one of the clustering algorithms comprises a first data point and a second data point, and the cluster satisfies at least one selected from a first group of relationships consisting of:
the first data point is not directly causally related to the second data point;
the first data point is a latent variable of the second data point;
the first data point is similar to the second data point because the first data point comprises a first attribute that is similar to a second attribute of the second data point; and
the first data point and the second data point follow a pattern.

17. A data processing system, comprising:
a processor; and
a memory coupled to the processor to store instructions, which when executed by the processor, cause the processor to perform operations managing data sources of a distributed system, the operations comprising:
obtaining a request for data to be used to provide desired computer implemented services;
generating embeddings of the data, wherein the embedding comprises a tag of the data, a timestamp of the data, and source information of the data;
generating a graph data structure based on the embeddings;
performing a similarity based search of the data sources for the data to identify a first portion of the data from the data sources;
performing a relationship based search of the data sources for the data using the graph data structure to identify a second portion of the data from the data sources, the graph data structure comprising:
nodes representing first portions of data stored in the data sources and available to service the request,
first edges based on explicit relationships between the first portions of the data, and
second edges based on inferred relationships between the first portions of the data; and
servicing the request using, at least in part, the first portion of the data and the second portion of the data to facilitate provisioning of the desired computer implemented services.

18. The data processing system of claim 17, wherein the inferred relationships are based on results generated by clustering algorithms to identify provisional inferred relationships.

19. The data processing system of claim 18, wherein the inferred relationships are obtained based on stakeholder voting regarding the provisional inferred relationships.

20. The data processing system of claim 19, wherein the stakeholder voting comprises voting, by stakeholders of the distributed system, to promote a third portion of the provisional inferred relationships to the inferred relationships.
